(19) United States
(12) Patent Application Publication
(10) Pub. No.: US 2013/0074965 A1
(43) Pub. Date: Mar. 28, 2013

(54) APPARATUS FOR PREVENTING WATER FROM FLOWING INTO HIGH VOLTAGE ELECTRONIC PARTS

(71) Applicant: Hae Kyu LIM, Seoul (KR)

(72) Inventor: Hae Kyu LIM, Seoul (KR)

(73) Assignees: Kia Motors Corporation, Seoul (KR); Hyundai Motor Company, Seoul (KR)

(21) Appl. No.: 13/313,996

(22) Filed: Dec. 7, 2011

(30) Foreign Application Priority Data
Sep. 26, 2011 (KR) 10-2011-0096708

(51) Int. Cl. F15D 1/00

(52) U.S. Cl. 137/899

(57) ABSTRACT

Disclosed is an apparatus for preventing water from flowing into high voltage electronic parts. More specifically, a grill and a diaphragm which is provided on a lower portion of the grill and formed so that water flows downward along an upper surface of the diaphragm when water flows through the grill. A duct which is provided on a lower portion of the diaphragm to allow airflow and formed so that a waterspout unit is formed by bending the outside thereof outward to receive water from the upper portion, prevents water from entering the unit containing the electronic parts by discharging the waster outside of the duct through the waterspout unit.

### CROSS-REFERENCE TO RELATED APPLICATION

This application claims under 35 U.S.C. §119(a) the benefit of Korean Patent Application No. 10-2011-0096708 filed on Sep. 26, 2011 the entire contents of which are incorporated herein by reference.

### BACKGROUND

(a) Technical Field

The present invention relates to an apparatus for preventing water from flowing into high voltage electronic parts when water flows into a grill for cooling of the high voltage electric parts.

(b) Background Art

In general, electric vehicles, hybrid vehicles or fuel cell vehicles use high voltage batteries to supply electrical energy for providing a driving force to the vehicles. The high voltage battery consists of a battery pack to produce high voltage by connecting a plurality of unit cells or modules and is able to generate the required high power using a high voltage battery.

In addition, systems related to the above-mentioned high voltage battery are designed to form one integrated structure assembled by various parts and the parts of the battery-related system may include a battery, an Low voltage Dc-dc Converter, an Motor Control Unit, an inverter and the like. That is, the energy stored in a high voltage battery is transmitted to a motor through the inverter to be used for a vehicle's start up, acceleration, and an engine's high-efficiency point operation, or the like, and when surplus energy is generated in the engine, the surplus energy is stored in the high voltage battery by using the motor as a generator.

The high voltage battery uses a. large amount of current and thereby since very large heat is generated in the inside thereof, the vehicle using the high voltage battery is provided with a cooling system to cool the high voltage battery and electronics.

FIG. 1 illustrates a configuration of an air cooling system using a vehicle's interior air among the mentioned air cooling systems in which the air is drawn in through an inlet 2 installed on a rear package tray 1 of the vehicle and cooling is achieved by forced air cooling the drawn in air into the battery-related parts. However, in a conventional vehicle, since the inlet 2 are installed where a majority of passengers often located. Thus, the inlet is exposed to various elements such as water and snow which could cause a short in the overall system since there is no structure currently designed to prevent admittance of liquids into the inlet of the air intake.

That is, if water or drinking water and the like are introduced into the inlet, the liquid materials flow into the high voltage electric parts. As discussed above, this could cause of a fatal failure of the high voltage electric parts and significantly inhibit the vehicle's safety due to an increased risk of short circuiting and fire.

### SUMMARY OF THE DISCLOSURE

The present invention provides an apparatus for preventing water from flowing into high voltage electric parts when water flows into a grill for cooling of the high voltage electric parts. More specifically, a grill which is installed on a vehicle's indoor side panel to drawn in air, and a diaphragm which is provided on the lower portion of the grill and formed so that water flows down along the upper surface of the diaphragm when water flows through the grill is provided. A duct is provided on the lower portion of the diaphragm to allow airflow and formed so that a waterspout unit is formed by bending the outside thereof outward to receive water from the upper portion. Accordingly, water is discharged outside through the waterspout unit formed therein.

In some embodiments, the diaphragm may be gradually formed so that the border is curved downward by curving the center portion outward, and the waterspout unit may be formed with a discharge aperture to discharge water.

Additionally, the waterspout unit may be provided downward along the border of the diaphragm, and may be slopingly formed by bending the outside thereof downwards.

Other aspects and preferred embodiments of the invention are discussed infra.

### BRIEF DESCRIPTION OF THE DRAWINGS

The above and other features of the present invention will now be described in detail with reference to certain exemplary embodiments thereof illustrated in the accompanying drawings which are given herein below by way of illustration only, and thus are not limitative of the present invention, and wherein:

FIG. 1 is a perspective view illustrating a configuration of an air cooling system according to the conventional art;

FIG. 2 is an exploded perspective view illustrating a configuration of a water flow prevention apparatus according to the present invention; and

FIG. 3 is a cross-sectional view illustrating a coupling structure of a water flow prevention apparatus according to the present invention.

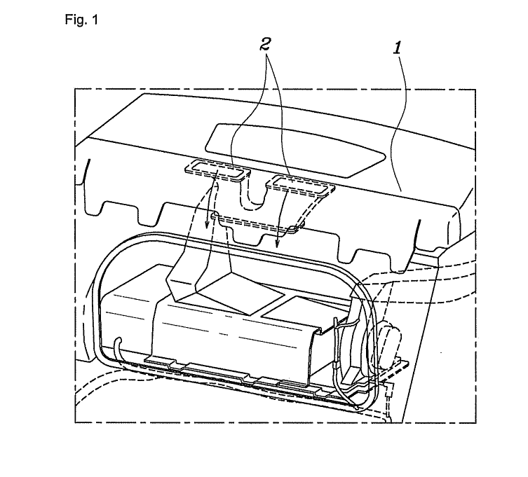

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that the present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

An apparatus for preventing water from flowing into high voltage electronic parts according to the present invention is configured to include a grill 10, a diaphragm 20 and a duct 30.

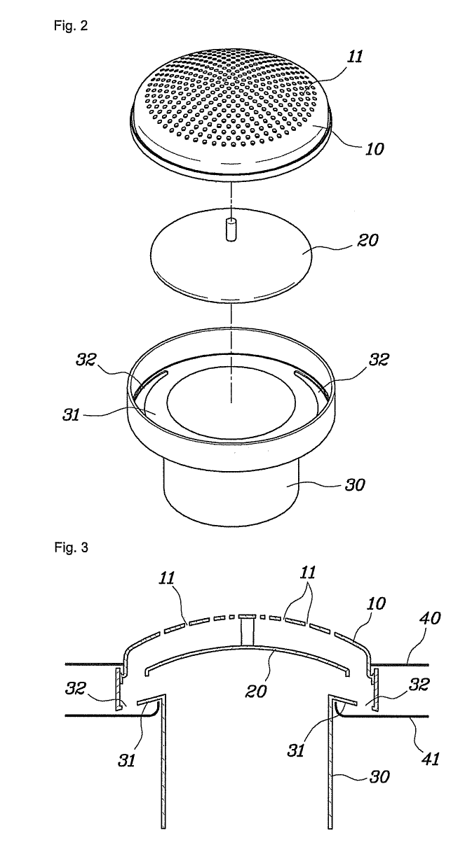

Referring to FIGS. 2 and 3, the grill 10 is installed on a panel of a vehicle's indoor side so that a portion of the upper surface is protruding therefrom, and air is drawn in through the grill 10. Herein, the grill 10 is preferably installed on a trim 40 of a rear package tray installed at the rear of the vehicle's interior. However, since this is just a preferred example for carrying out the present invention, the installation location may be preferably changed in accordance with installation locations of a high voltage battery and electronics accordingly.

In addition, the grill 10 has the center portion convexly formed upwards and the upper surface formed as a lattice and is provided with a plurality of apertures. In this case, the apertures 11 may be preferably formed so that air is passed there through and have a size proportioned so as to prevent foreign materials from being admitted into the system. Meanwhile, the grill may be formed variably in addition to the lattice shape, and is thus not limited thereto.

The diaphragm 20 is intended to be provided in the lower portion of the grill 10 and formed so that water flows down along the upper surface of the diaphragm 20 when water flows through the grill 10. Herein, the diaphragm 20 is formed with a protrusion at the center of the upper surface and the protrusion is fixed to the center of the lower surface of the grill 10 such that the diaphragm 20 may be configured as a unified form with the grill 10 (i.e., as one unit).

The duct 30 is provided on the lower portion of the diaphragm 20 to allow airflow and a waterspout unit 31 is formed by bending the outside thereof outward to receive water from the upper portion so that water flows outside of the unit structure through the waterspout unit 31.

Herein, the duct 30 may be installed so that the upper end of the duct 30 may be fixed to the lower end of the grill 10. In addition, the lower portion of the duct 30 may be configured to penetrate a vehicle body 41 of a rear package tray and the lower surface of the waterspout unit 31 is installed on the vehicle body 41 of the rear package tray.

In the illustrative embodiment of the present invention, a portion of the vehicle body 41 of the rear package tray 41 on which the waterspout unit 31 is securely mounted, is formed by bending an outside portion thereof toward the upper portion so that water dropping from the waterspout unit 31 may be prevented from flowing into the duct 30 while the duct 30 is securely mounted.

Herein, the duct 30 may be applied in a duct of a package tray as described above and in addition, may be applied in an inlet duct. Furthermore, a portion of the duct 30 may be installed with a fan so that air flows inside the duct 30 through the grill 10. That is, when air flows through the aperture 11 formed on the grill 10, the air passes a space provided between the grill 10 and the diaphragm 20 and passes through a space provided between the diaphragm 20 and the duct 30 to allow air to flow inside the duct 30 so that high voltage electric parts may be cooled.

However, if water flows through an aperture 11 formed on the grill 10, the water is dropped onto an upper surface of the diaphragm 20 and then flows down toward the lower portion away from the electronic parts. In this case, since the lower portion of the diaphragm 20 on which water is dropped is provided with the waterspout unit 31, water dropped on the waterspout unit 31 is discharged outside of the duct/unit 30 and then the water flowing into the high voltage electric parts is prevented.

In addition, the diaphragm 20 is gradually formed so that the border is curved downward by curving the center portion outward. That is, since the shape of the diaphragm 20 is convexly formed toward the upper portion of the duct around the center portion thereof, water dropped on the diaphragm 20 more smoothly flows down toward the border of the diaphragm 20.

Furthermore, the waterspout unit 31 is formed with discharge apertures 32 to efficiently discharge water. That is, since a plurality of discharge apertures 32 are formed along the border of the waterspout unit 31 and the discharge apertures 32 are located at the upper side of the vehicle body 41 of the rear package tray, water discharged through the discharge apertures 32 is dropped on the vehicle body 41 of the rear package tray so that the water may be discharged to outside of the ducting.

In addition, the waterspout unit 31 is provided downward along the border of the diaphragm 20. That is, since the lower position of the border of the diaphragm 20 is installed with the waterspout unit 31, even though water is dropped anywhere on the border of the diaphragm 20, the water is received in the waterspout unit 31. The waterspout unit 31 is slopingly formed by bending the outside thereof downwards. Therefore, the present invention essentially prevents water dropped onto the waterspout unit 31 from flowing into the inside of the duct 30 and water dropped onto the waterspout unit 31 can be efficiently discharged outside of the duct 30.

According to the present invention, when water is introduced into the inside of the grill, the water is dropped on the waterspout unit by the diaphragm and discharged outside of the duct. Therefore, since the present invention prevents water from flowing into high voltage electronic parts, the present invention prevents/reduces the risk of short circuit and fire.

In addition, since the waterspout unit is slopingly formed by bending the outside thereof downwards and the waterspout unit is formed with a discharge aperture, failure of the electronic parts to water flow into the unit can be largely reduced by dropping water onto a waterspout unit as it is flowing into the duct.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. An apparatus for preventing water from flowing into high voltage electronic parts, comprising:
a grill installed on an indoor side panel of a vehicle to draw in air therethrough;
a diaphragm provided on a lower portion of the grill and formed so that water flows down along an upper surface of the diaphragm when water flows through the grill; and
a duct provided on a lower portion of the diaphragm to allow airflow therethrough and formed so that a waterspout unit is formed by bending an outside portion thereof outward and configured to receive water from an upper portion and water is discharged to outside the duct through the waterspout unit.

2. The apparatus of claim 1, wherein the diaphragm is gradually formed so that a border is curved downward by curving a center portion outward.

3. The apparatus of claim 1, wherein the waterspout unit is formed with discharge apertures to discharge water.

4. The apparatus of claim 1, wherein the waterspout unit is provided downward along a border of the diaphragm.

5. The apparatus of claim 1, wherein the waterspout unit is slopingly formed by bending an outside thereof downwards.

6. An apparatus, comprising:
a grill;
a diaphragm provided on a lower portion of a grill and formed so that water flows down along an upper surface of the diaphragm when water flows through the grill;
a duct provided on a lower portion of the diaphragm to allow airflow therethrough and formed with a waterspout unit is formed by bending an outside portion thereof outward and configured to receive water from an upper portion and discharge the water outside the duct through the waterspout unit.

7. The apparatus of claim 6, wherein the diaphragm is gradually formed so that a border is curved downward by curving a center portion outward.

8. The apparatus of claim 6, wherein the waterspout unit is formed with discharge apertures to discharge water.

9. The apparatus of claim 6, wherein the waterspout unit is provided downward along a border of the diaphragm.

10. The apparatus of claim 6, wherein the waterspout unit is slopingly formed by bending an outside thereof downwards.
